(19) United States
(12) Patent Application Publication
(10) Pub. No.: US 2013/0096988 A1
(43) Pub. Date: Apr. 18, 2013

(54) NOMINATION ENGINE

(71) Applicant: MASTERCARD INTERNATIONAL, INC., Purchase, NY (US)

(72) Inventors: David Grossman, Brooklyn, NY (US); Anna Hsu, Larchmont, NY (US); Maria D'Albert, Brooklyn, NY (US); Steven Bruce Oshry, Bronxville, NY (US); Henry Weinberger, New York, NY (US)

(73) Assignee: MASTERCARD INTERNATIONAL, INC., Purchase, NY (US)

(21) Appl. No.: 13/646,285

(22) Filed: Oct. 5, 2012

Related U.S. Application Data
(60) Provisional application No. 61/543,681, filed on Oct. 5, 2011.

(51) Int. Cl. G06Q 30/02

(52) U.S. Cl. CPC G06Q 30/0205
USPC 705/7.34

(57) ABSTRACT

A system and method for nominating candidate enterprises for inclusion in a competitive set assembled for the purpose of competitively analyzing a subject enterprise. Characteristics of the subject enterprise in which the subject enterprise is comparable to a plurality of candidate enterprises are identified. The characteristics may include location, size of the physical presence, a dollar volume of revenue, classification of the business engaged, market share, average purchase size; of the subject purchase frequency of customers; size of customer base; demographic characteristics of the customer base, location of customers, degree of customer loyalty, and share of the customer's wallet. A list candidate enterprises is compiled based upon a predetermined degree of similarity between the subject enterprise and/or an identified competitor enterprise on the one hand, and the candidate enterprise on the other. A plurality of nominee enterprises are selected from the list of candidates to populate the competitive set.

### CROSS REFERENCE TO RELATED APPLICATIONS

The instant application claims the priority benefit under 35 U.S.C. §119(e) of prior U.S. Provisional Patent Application Ser. No. 61/543,681, titled NOMINATION ENGINE, filed 5 Oct. 2011 by the instant inventive entity. The complete contents and disclosure of said priority application are hereby incorporated herein by this reference in their entirely for all purposes.

### BACKGROUND

1. Field of the Disclosure

The present disclosure relates to business analysis. More specifically, disclosed is a system and method for nominating a proposed set of peer competitors to a business enterprise for benchmarking, performance analysis, competitive analysis, acquisition of, retention of, and promotion to customers of that business enterprise, to aid in planning operations and growth.

2. Brief Discussion of Related Art

In the field of business management, it is valuable to be able to benchmark the performance of the business as compared to its peers. From this benchmark analysis, a business operator can identify if any observed changes to business operating characteristics are based on operational factors that are particular to that business or location, or whether similar peer business are being affected similarly, and thus can conclude that the marketplace is being subjected to contemporaneous secular economic influences affecting all peer businesses. With this information, the business operator can identify operational areas where changes can be focused to meet or exceed peer performance.

MASTERCARD ADVISORS, a merchant services arm of MasterCard International, Inc., the assignee of the present application, has used data derived from its handling of purchase transactions to allow businesses to compare their performance to that of an aggregated set of their peers. This product has been marketed under the brand name Benchmark Analytics, among others (e.g., Market Vision Reports, Customer Analytics, Custom Analytics, Specialized Analytics and Customer File Enhancement). Benchmark Analytics in particular is a Web-based application that delivers comparative performance data directly to the merchant via their computer desktop.

Benchmark Analytics provides merchants the ability to examine spending and growth in their locations—from the national level to the metropolitan statistical area (MSA) or designated market area (DMA) level—against overall performance in their industry category, and against a defined, aggregated set of competitors. Performance may be tracked over time, and across multiple loyalty-based segments. This information can help guide businesses in making decisions about advertising and marketing, buying, merchandising, and operations.

The particular problem that is the subject of the present disclosure is how to select a competitive peer group. In the case of larger national (even international) entities, the universe of comparable peer competitor business is few and fairly well defined. However, the selection of a suitable peer group is considerably more difficult for smaller and/or more localized business entities. The sheer number of potential competitor entities requires that some discrimination be applied to the selection. Therefore, the market for smaller businesses or local branches of larger entities seeking to take advantage of what competitive benchmarking can offer them is underserved by the failure to overcome this obstacle, and the present state of the art is therefore lacking.

### SUMMARY

In order to overcome these and other weaknesses, drawbacks, and deficiencies in the known art, provided according to the present disclosure is a system and method for nominating candidate enterprises for inclusion in a competitive set assembled for the purpose of benchmarking a subject enterprise. The system includes a processor and a non-transitory storage medium having instruction which when executed by the processor cause the processor to execute the corresponding method of the present disclosure.

The method includes an identification or a self-identification of a subject enterprise from an agent thereof. Characteristics of the subject enterprise and/or an identified competitor enterprise in which the subject enterprise is comparable to a plurality of candidate enterprises for inclusion in a competitive set are identified. The characteristics may include, without limitation, one or more of a geographic location of the subject enterprise, a size of the physical presence of the subject enterprise, a dollar volume of revenue of the subject enterprise, a classification of the business engaged by the subject enterprise, firmographic attributes of the subject enterprise, market share of the subject enterprise, average purchase size of the subject enterprise, purchase frequency of customers of the subject enterprise, size of customer base of the subject enterprise, commonality of the customer base, either by identity of customers or customer sets having common characteristics, demographic characteristics of the customer base of the subject enterprise, location of customers of the subject enterprise, degree of customer loyalty to the subject, the subject enterprise's share of the customer's wallet, the channels of trade engaged in by the subject enterprise, and attributes pertaining to the interaction between the subject enterprise and third parties, among them and without limitation service providers, suppliers and resellers.

A list of candidate enterprises is compiled based upon a predetermined degree of similarity between the subject enterprise and/or an identified competitor enterprise on the one hand, and the candidate enterprise on the other, in one or more of the identified characteristics. From the list of candidate enterprises, a plurality of nominee enterprises are selected to populate the competitive set.

### BRIEF DESCRIPTION OF THE FIGURES

These and other purposes, goals and advantages of the present application will become apparent from the following detailed description of example embodiments read in connection with the accompanying drawings, wherein

FIG. 1 illustrates a process of peer merchant candidate selection and ranking;

FIG. 2 illustrates a process for the selection and validation of a competitive set of peer merchants against which to benchmark a client merchant;

FIG. 3 illustrates a process; and

FIG. 4 schematically illustrates a processing device to carry out the forgoing processes.

### DETAILED DESCRIPTION

A data provider therefore seeks to provide its client with a competitive benchmark data set, and the client wishes to obtain the same. The competitive market data to be provided is customized to the merchant client. Therefore, at the outset of the process, the client identifies themselves, and certain characteristics of their business operations. These characteristics may include one or more of location, size (e.g., square footage), revenue, business type (e.g., as classified by a standardized catalog of fields of business, such as merchant category/classification code, MCC), among others. In a particularly contemplated example of the present disclosure, the client is an existing customer of the data provider for other services, for example transaction clearing payment services. Therefore, the data provider will know some or all of these characteristics on the basis of this pre-existing business relationship.

Subsequent to self-identifying to the data provider, the client may self-select the entities which they believe to be relevant competitors for inclusion in a competitive set. In certain cases, the client may not have an established profile of characteristics sufficient to serve as the baseline for comparison to candidate competitors. In that case, the data provider may look to the characteristics of the competitive entities selected by the client to identify pertinent characteristics of those entities. The data provider could then expand the search for candidates to populate the competitive set by looking for candidates similar to the identified competitors. In this way, the identified competitors may represent as an aspiration of characteristics the client seeks to achieve.

Competitive Set Selection/Population

The self-selection of competitors by the client can be augmented by the data provider in one of several ways. For example, the data provider may begin with the location of the subject merchant and look outward for candidate businesses within a predefined distance radius from that location. In addition to the consideration of proximity to the subject merchant business, a candidate business for inclusion in the competitive set could be in a similar field of endeavor. One means for identifying the field of endeavor is by reference to the MCC of the candidate business. The catalog of MCCs has some usefulness, but some drawbacks as well. Other classification schemes or hierarchies may be employed in addition to or in place of the MCCs.

Alternately or additionally to consideration of distance or line of business, if it is necessary to expand or limit the pool of candidate businesses, the data provider can look for similarities between the subject merchant and the candidate businesses with respect to the benchmark data itself, in order to identify businesses that would be likely candidates for inclusion in the competitive set. The benchmark data categories contemplated to be provided by the data provider to the client include market share, purchase size, purchase frequency, customer base, location of customer (e.g., by zip code), among others. The data provider can look for similarities between the client and candidate businesses in one or more of these areas to determine if a business is a candidate for inclusion in the competitive set.

The data provider may also look to the transaction data of the customers of the subject merchant to look for candidates to populate the competitive set. For example, considering a subject merchant and looking to the transaction data of their current customer base, it may be seen that those clients patronize similar business not within an arbitrary distance radius or in a different merchant classification. It may be apparent from the customer base data, by broadening the merchant classification (i.e., restaurants generally v. Italian restaurants), that addition candidates for inclusion in the competitive set are identified that might otherwise have been omitted. Therefore, analysis of the subject merchant's customer behavior may identify candidate businesses for inclusion in the competitive set. In other words, the characteristic for comparison or identification of candidate peer enterprises to populate the competitive benchmark set is a degree of commonality in customer base—do the same customers patronize the candidate peer merchant as do the subject merchant? A higher degree of commonality may make the candidate merchant a viable peer for inclusion in the competitive set.

Other characteristics that make a subject merchant a good candidate for inclusion in the per merchant benchmarking set are if the candidate merchant engages in similar channels of trade as the client merchant. Channels of trade can include any of various ways that the customer interacts with the business to make their purchase. For example, a customer may visit a “brick & mortar” location of the merchant, including for example a showroom, to view and sample product, or receive services. Alternately, the customer may interact with the merchant online via an internet website. The merchant may provide a catalog and take phone or mail-orders. The channels of trade may also include the use of resellers. Therefore, the channels of trade, expressed for example as relative proportions of sales received through each of a defined number of channels, may be relevant for comparison between the subject merchant and a candidate peer merchant.

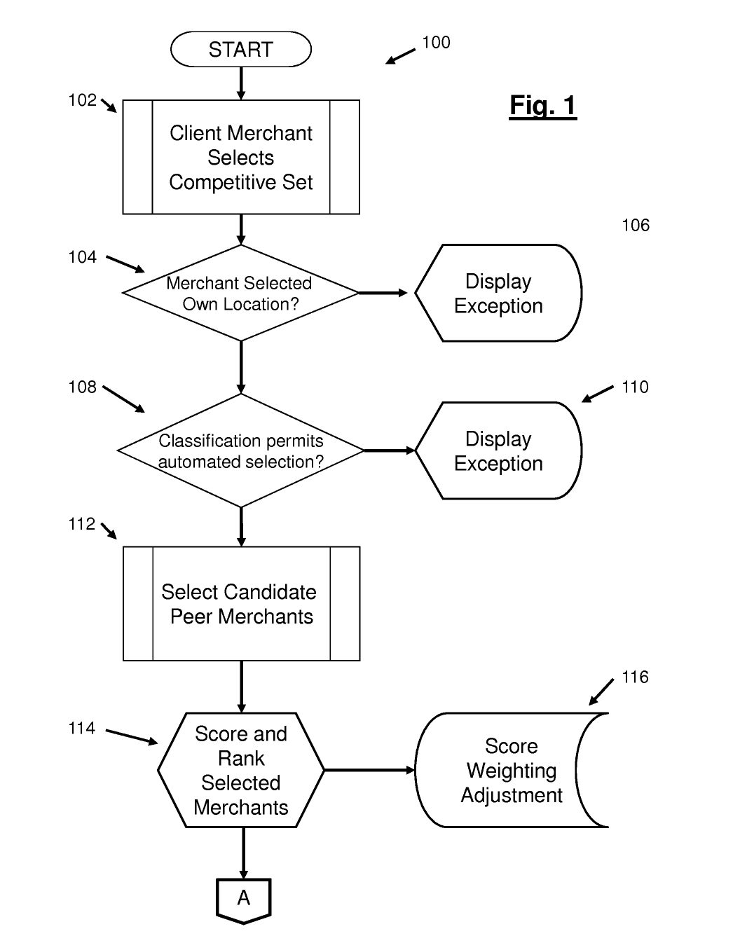

Referring now to FIG. 1, illustrated is a flowchart depicting a process, generally 100, for merchant peer nomination. The client selects their own proposed peer group 102. This proposed peer group is preliminarily screened. For example, the client-selected peer group is queried 104 to determine if the subject merchant themselves is within the group. If not, an exception is raised 106, and the process is interrupted. Upon the raising of an exception, the client may be referred to a consultant for assistance in completing the peer group nomination process.

Alternately or additionally to the verification of the merchant's inclusion in the peer group, the method checks the subject merchant classification (e.g., MCC code) for adequate specificity 108. In the case where the merchant classification is a hierarchical one, the MCC should be one of a Tier 2 (e.g., subdivision level) classification in order to have confidence that peer merchant sharing the same MCC code will have sufficient similarity with the subject merchant to be relevant for comparison. If the subject merchant MCC code is not at least a Tier 2 level, an exception 110 can be raised.

Alternately or additionally, if the subject merchant's Tier 2 MCC classification code is one of a number of miscellaneous codes, here again there is sufficient variation among businesses sharing the same code that the comparison might not be as relevant as the client might like. Again, if the subject merchant MCC code is a miscellaneous code, despite being a Tier 2 code, nonetheless an exception is raised 110.

Having passed these preliminary checks, an automated sub-process 112 for peer group candidate selection is executed. Namely, a candidate pool of prospective peer merchants is identified from among all merchants in a stored database. To qualify as a candidate peer merchant, the merchant must have a similarity of MCC code with the subject merchant, either because the two share a Tier 2 code, where the Tier 2 code is defined in the hierarchy or taxonomy as a standalone classification, otherwise the candidate merchant must share an MCC code with the subject merchant at least at the Tier 1 level. Furthermore, a candidate merchant must be within a specified distance to the subject merchant to ensure geographic relevancy. Optionally, the threshold distance from the subject merchant is adjusted according to the population density of the subject merchant's location. That is, where the subject merchant's location is in an area of low population density, presumably a broader radius is necessary to gather a sufficient number of candidate peer merchants for comparison. The precise radius may be dynamic, e.g., dependent upon the number of candidates gathered by a given radius. It may optionally also be directionally cognizant, e.g., if in one direction of a merchant the population density increases, the threshold radius can reflect this. Similarly, if population density decreases in another direction, likewise and opposite.

The pool of candidate peer merchants selected in process 112 are then ranked and/or weighted 114 according to one or more criteria. Among the criteria are the distance of the candidate merchant location from the subject merchant location. However, the distance itself may optionally be weighted according to population density in a weighting sub-process 116. In areas of low population density, greater distances between the candidate merchant and subject merchant have less impact on the candidate merchant score, as all businesses in general are presumably farther from one another. Therefore, the distance weighting can be a sliding scale inverse with population density. If the population density is unknown, a default value on the sliding scale is selected.

Other factors that may affect the scope of a particular candidate merchant include the specific MCC code of that merchant as compared with the subject merchant. Where the two share an identical Tier 2 MCC code, the candidate merchant may be weighted higher. Candidate merchants with an average purchase amount within a threshold of the subject merchant may be weighted higher as being more similar. Optionally, candidate merchants have a physical location size that is within a threshold of the subject merchant may also be weighted higher. Similarity between the subject merchant and the candidate merchant in the distribution of channels of trade may be used to weight certain candidate merchants higher.

The intent of weighting is to choose from the candidate pool merchants that are most similar to the subject merchant based on objective measures, to ensure a valid comparison. Any business characteristic of the candidate merchant that is determinable from the merchant data in the database can be used to weight and compare candidate merchants with respect to the subject merchant.

Candidate merchants ranked at 114 are ordered in descending order of the weighted ranking. The top of this ordered pool of candidate merchants, and preferably some multiple greater number of candidates than the number is anticipated to be needed to populate the competitive set, is kept for further processing.

Competitive Set Validation

From among the candidate businesses identified either by the client or the data provider, the client may select some or all for inclusion in the competitive set. Additionally, there are certain consideration and characteristics of an acceptable competitive set. For statistical accuracy, among other concerns, a suitable competitive set should have a sufficient number of member competitors to form a meaningful sample of businesses of the same type as the subject merchant. For certain benchmark metrics, it should also be the case that no one business in the competitive set dominates the characteristics of the set to the limitation or exclusion of the influence exerted by other businesses that are co-members of the competitive set.

It is further contemplated that the makeup of the competitive set not be changed with great frequency. The number of changes to the competitive set may be restricted for a given time frame. Further, the nature of any changes can be limited to preclude any change in competitive set makeup from revealing, by implication, data attributable to any single entity that is newly or was formerly comprised in the competitive set.

Furthermore, the consideration and determination of criteria for selection and population of a competitive set may be reduced to objective criteria and guidelines that lend themselves to automated implementation. Accordingly, the identification or self-identification of the subject merchant, self-selection of candidates for the competitive set, and pre-established criteria for supplementing the client's self-selection all lend themselves to automated implementation. To this end, particularly convenient methods (GUI, web-based, mobile, etc.) for the client to interface with and guide the competitive set population process may facilitate the selection process.

The client may initiate the process by interaction with a computer-based and largely automated system. The client may select or self-select from a list of merchants, with optional pre-selection filtering according to one or more criteria, including those criteria by which the competitive set is validated, e.g. and without limitation, size (e.g., square footage), revenue, business type (e.g., as classified by a standardized catalog of fields of business, such as merchant category/classification code, MCC), among others.

Additionally, the establishment of objective criteria and guidelines for the selection of businesses that comprise the competitive set may obviate the client's participation in the selection process. Therefore, the client's nomination of candidate enterprises for inclusion in the competitive set, and/or their selection of businesses from among the nominees for inclusion in the competitive set may be considered optional. A subset of the nominated candidates may be selected by the data provider according to a degree of statistical similarity between the subject merchant and the one or more selected candidates (market share, purchase size, purchase frequency, inter alia described elsewhere herein).

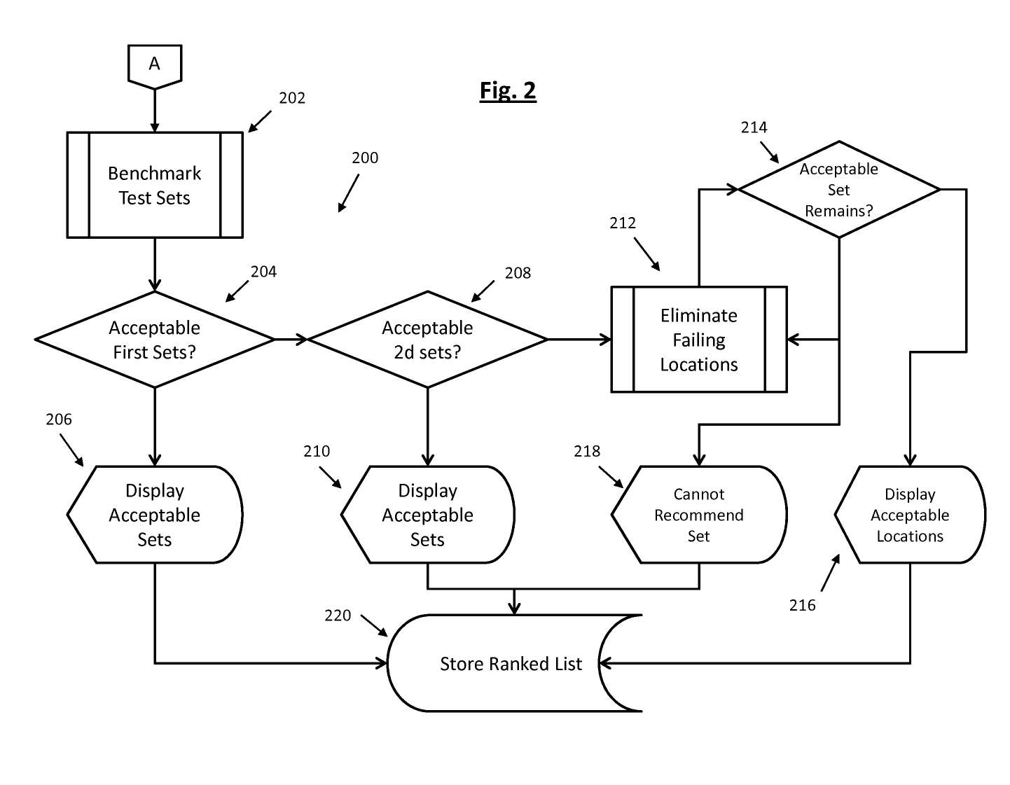

Referring now to FIG. 2, illustrated is a validation process generally 200, according to an exemplary embodiment of the present disclosure. In process 114 a top sample of rank-ordered candidate merchants to populate a comparative set is identified. Process 202 operates to calculate a benchmark pass/fail for a number of test sets, the sets being a range of set sizes, i.e., taking between some minimum number and some practical or workable maximum number of the top candidate merchant locations in the list.

In one embodiment of the present disclosure, the scenarios using between a minimum 5 and some preferred number×merchants are analyzed 204 to determine if the sets are acceptable under a benchmarking test. For example, the US Department of Justice and Federal Trade Commission have promulgated guidance that indicates acceptable practices for the use and dissemination of competitive market data. More specifically, data must be sufficiently aggregated such that no fewer than five entities' data makes up the set, and further no one entity may represent more than 25% of the aggregated data. For this analysis 204, the set having the largest number of merchants which still passes the benchmarking test is generally desired. Accordingly, the selected set of peer merchants may be presented to the client 206. Alternately, any sets among these that pass the benchmark test can be presented to the client for their selection. Still alternately or additionally, the passing scenarios can be ranked, for example by benchmark score or some other measure, and listed to the client in rank order.

In the case that the analysis 204 is negative, the results of process 202 are further analyzed 208 to determine whether any of the sets including between x and y (where y>x) candidate merchants would be acceptable under a benchmarking test as described above. For this analysis 208, set having the least number of merchants which still passes the benchmarking test is generally desired. Accordingly, the selected set or peer merchants may be presented to the client 210. Alternately, any sets among these that pass the benchmark test can pre presented to the client for their selection. Still alternately or additionally, the passing scenarios can be ranked, for example by benchmark score or some other measure, and listed to the client in some rank order.

In the case that the analysis 208 is negative, the list of the top y merchants is investigated, and any failing locations on the list are eliminated. A failing location in this sense is any candidate merchant whose inclusion causes the test competitive set to fail the applicable benchmark test. For example, and without limitation, based on the 5 and 25% criteria described above, ‘failing locations’ may be considered those in the set whose data make up the greatest proportion of the relevant values measured, and thus cause the set to fail that particular benchmark test.

Among the remaining locations in the set of y, a benchmarking test is applied 214. Where the remaining set passed the benchmark test, the satisfactory set of merchants is displayed to the client 216. If not, among the remaining locations and further failing locations are removed from the set via 212, and the remainder evaluated for benchmark passage. This process of failing location removal and retesting can be reiterated until a successful result set is achieved, or a minimum number of candidate peer merchant locations remain, e.g. five or fewer according to the guidance cited above. In the latter case, a message is delivered 218 to the client that no peer group recommendation could be made. Optionally, as part of the validation process 200, a ranked list of unused locations, including eliminated failed locations (see 212) can be retained 220.

Optionally or additionally, the location recommendation engine can be implemented to expand on the list of peer merchants supplied by the client. For example, the client-selected peer set may or may not satisfy a benchmark test. In either case, a recommendation to expand the peer group set can operate as follows.

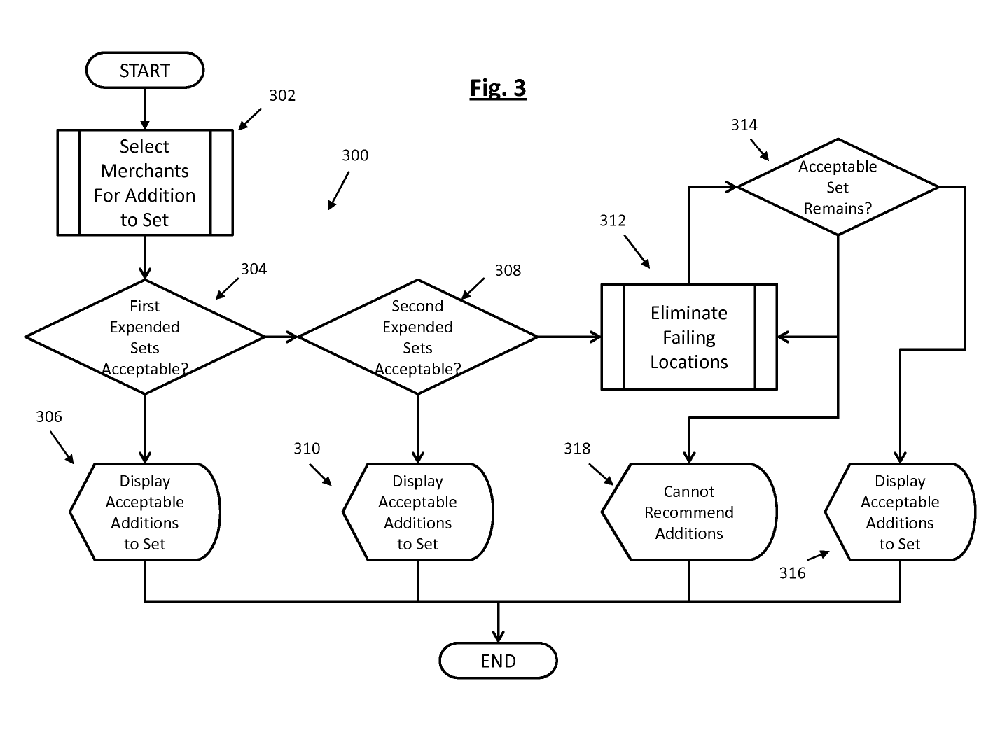

Referring now to FIG. 3, illustrated is en expansion process, generally 300, according to an exemplary embodiment of the present disclosure. Some number (N) of peer merchants will have been selected by the client for inclusion in the competitive set. A process for rank-ordering candidate peer merchants, more specifically 114, would be executed, as described above with reference to the above description and FIG. 1.

In process 114 a top sample of rank-ordered candidate merchants to populate a comparative set. Process 302 selects an additional “n” number of those merchants, and calculates a benchmark pass/fail for each test set including the client provided candidates and between 1 and n of the top candidate additional merchant locations.

In one embodiment of the present disclosure, the scenarios using between 1 and m (where m<n) additional merchants are analyzed 304 to determine if they are acceptable under an applicable benchmarking test. For this analysis 304, set having the largest number of merchants which still passes the benchmarking test is generally desired. Accordingly, the selected set of peer merchants may be presented to the client 306. Alternately, any sets among these that pass the benchmark test can pre presented to the client for their selection. Still alternately or additionally, the passing scenarios can be ranked, for example by benchmark score or some other measure, and listed to the client in rank order.

In the case that the analysis 304 is negative, the results of process 302 are further analyzed 308 to determine whether any of the sets including between m and n additional candidate merchants would be acceptable under an applicable benchmarking test. For this analysis 308, set having the least number of merchants which still passes the benchmarking test is generally desired. Accordingly, the selected set or peer merchants may be presented to the client 310. Alternately, any sets among these that pass the benchmark test can pre presented to the client for their selection. Still alternately or additionally, the passing scenarios can be ranked, for example by benchmark score or some other measure, and listed to the client in some rank order.

In the case that the analysis 308 is negative, the list of the n additional merchants is investigated, and any failing locations on the list are eliminated. Among the remaining locations in the additional set of n, a benchmarking test is applied 314. Where the remaining set passes the benchmark test, the satisfactory set of merchants is displayed to the client 316. If not, among the remaining locations and further failing locations are removed from the set via 312, and the remainder evaluated for benchmark passage. This process of failing location removal and retesting can be reiterated until a successful result set is achieved, or no additional merchants remain. In the latter case, a message is delivered 318 to the client that no additional location recommendation could be made.

Market Vision Report

Having populated and validated the competitive set, the transaction data, characteristics, customer characteristics, behaviors, performance or business practices of the client can be compared to that of the competitive set. Among the data that business find to be useful metrics are market share; average purchase size (aka, average ticket); purchase frequency; size of customer base; location of customers (or ‘feeder’ zip codes).

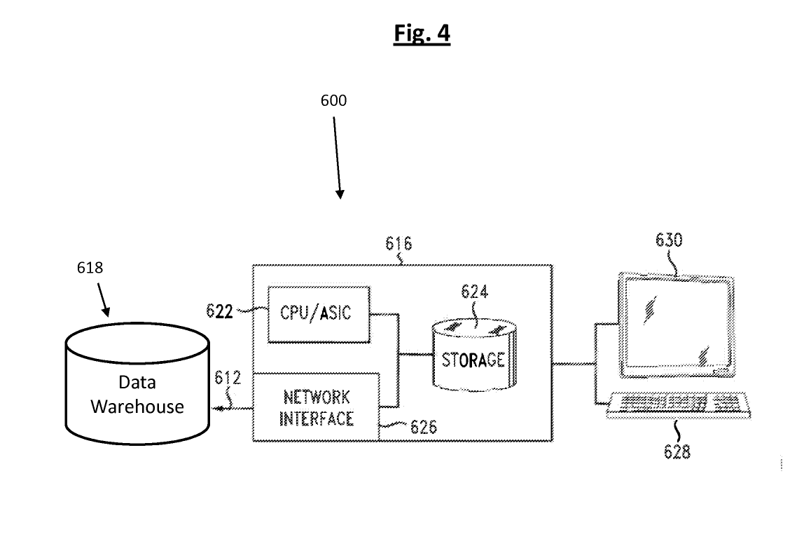

Turning then to FIG. 4, illustrated schematically is a representative computer 616 of a system 600 operative to carry out the above-defined methods and processes. The computer 616 includes at least a processor or CPU 622 which is operative to act on a program of instructions stored on a computer-readable medium 624. Execution of the program of instruction causes the processor 622 to carry out, for example, the methods described above according to the various embodiments. It may further or alternately be the case that the processor 622 comprises application-specific circuitry including the operative capability to execute the prescribed operations integrated therein. The computer 616 will in many cases includes a network interface 626 for communication with an external network 612 for access to a data storage 618, colloquially called a data warehouse. Optionally or additionally, a data entry device 628 (e.g., keyboard, mouse, trackball, pointer, etc.) facilitates human interaction with the server, as does an optional display 630. In other embodiments, the display 630 and data entry device 628 are integrated, for example a touch-screen display having a GUI.

It will be appreciated that variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A method of identifying candidate enterprises for inclusion in a competitive set assembled for the purpose of competitively analyzing a subject enterprise, the method comprising:
identifying characteristics of the subject enterprise the characteristics including one or more of a geographic location of the subject enterprise, a size of the physical presence of the subject enterprise, a dollar volume of revenue of the subject enterprise, a classification of the business engaged by the subject enterprise, firmographic attributes of the subject enterprise, market share of the subject enterprise, average purchase size by customers of the subject enterprise, purchase frequency by customers of the subject enterprise, size of customer base of the subject enterprise, commonality of the customer base, demographic characteristics of the customer base of the subject enterprise, location of customers of the subject enterprise, degree of customer loyalty to the subject, the subject enterprise's share of the customer's wallet, the channels of trade engaged in by the subject enterprise, and attributes pertaining to the interaction between the subject enterprise and third party suppliers, service providers or resellers;
compiling a list of candidate enterprises based upon a predetermined degree of similarity between the subject enterprise and/or the identified competitive enterprise on the one hand, and the candidate enterprise on the other, in one or more of the identified characteristics; and
selecting a first plurality of nominee enterprises to populate the competitive set from among the list of candidate enterprises for inclusion in the competitive set.

2. The method according to claim 1 wherein selecting a first plurality of nominee enterprises comprises receiving a selection from an agent of the subject enterprise.

3. The method according to claim 1 wherein selecting a first plurality of nominee enterprises comprises selecting all of the nominee enterprises.

4. The method according to claim 1, wherein the predetermined degree of similarity between the subject enterprise and the candidate enterprise in one or more of the identified characteristics is determined according to a fuzzy logic criteria based upon a second plurality of the characteristics.

5. The method according to claim 1, wherein identifying characteristics of the subject enterprise comprises adopting one or more characteristics of an identified competitive entity to which the subject enterprise is deemed comparable.

6. The method according to claim 1, further comprising ranking the candidate list of enterprises according to a specified degree of similarity with the subject enterprise, wherein selecting a first plurality of nominee enterprises to populate the competitive set further comprises selecting plurality of nominee enterprises according to their ranking.

7. The method according to claim 1, further comprising validating the competitive set of nominee enterprises for compliance with predetermined validation criteria.

8. The method according to claim 7, further comprising iteratively modifying the population of the competitive set from among the candidate enterprises in response to the competitive set not complying with the predetermined validation criteria.

9. The method according to claim 1, wherein selecting a first plurality of nominee enterprises to populate the competitive set comprises selecting a third plurality of such first pluralities of nominee enterprises; and
validating each of the third pluralities for compliance with predetermined validation criteria.

11. The method according to claim 2, wherein a first plurality of nominee enterprises further comprises one or more of the candidate enterprises to supplement the selection received from an agent of the subject enterprise.

12. A system for nominating candidate enterprises for inclusion in a competitive set assembled for the purpose of benchmarking a subject enterprise, the system comprising:
a processor; and
a non-transitory storage medium having instruction which when executed by the processor cause the processor to:
receive an identification or self-identification of the subject enterprise from an agent thereof;
identify characteristics of the subject enterprise, the characteristics including one or more of a geographic location of the subject enterprise, a size of the physical presence of the subject enterprise, a dollar volume of revenue of the subject enterprise, a classification of the business engaged by the subject enterprise, firmographic attributes of the subject enterprise, market share of the subject enterprise, average purchase size by customers of the subject enterprise, purchase frequency by customers of the subject enterprise, size of customer base of the subject enterprise, commonality of the customer base, demographic characteristics of the customer base of the subject enterprise, location of customers of the subject enterprise, degree of customer loyalty to the subject, the subject enterprise's share of the customer's wallet, the channels of trade engaged in by the subject enterprise, and attributes pertaining to the interaction between the subject enterprise and third party suppliers, service providers or resellers;
compile a list of candidate enterprises based upon a predetermined degree of similarity between the subject enterprise and/or the identified competitive enterprise on the one hand, and the candidate enterprise on the other, in one or more of the identified characteristics; and
select a first plurality of nominee enterprises to populate the competitive set from among the list of candidate enterprises for inclusion in the competitive set.

13. A non-transitory storage medium having instructions thereon which, when executed by a processor, cause the processor to:
receive an identification or self-identification of the subject enterprise from an agent thereof;
identify characteristics of the subject enterprise, the characteristics including one or more of a geographic location of the subject enterprise, a size of the physical presence of the subject enterprise, a dollar volume of revenue of the subject enterprise, a classification of the business engaged by the subject enterprise, firmographic attributes of the subject enterprise, market share of the subject enterprise, average purchase size by customers of the subject enterprise, purchase frequency by customers of the subject enterprise, size of customer base of the subject enterprise, commonality of the customer base, demographic characteristics of the customer base of the subject enterprise, location of customers of the subject enterprise, degree of customer loyalty to the subject, the subject enterprise's share of the customer's wallet, the channels of trade engaged in by the subject enterprise, and attributes pertaining to the interaction between the subject enterprise and third party suppliers, service providers or resellers;
compile a list of candidate enterprises based upon a predetermined degree of similarity between the subject enterprise and/or the identified competitive enterprise on the one hand, and the candidate enterprise on the other, in one or more of the identified characteristics; and
select a first plurality of nominee enterprises to populate the competitive set from among the list of candidate enterprises for inclusion in the competitive set.
